(19) United States
(12) Patent Application Publication
(10) Pub. No.: US 2014/0258820 A1
(43) Pub. Date: Sep. 11, 2014

(54) Providing Information During Different Stages of a Design Cycle

(71) Applicant: Texas Instruments Incorporated, Dallas, TX (US)

(72) Inventor: Gary Lynn Swoboda, Sugar Land, TX (US)

(73) Assignee: Texas Instruments Incorporated, Dallas, TX (US)

(21) Appl. No.: 14/196,918

(22) Filed: Mar. 4, 2014

Related U.S. Application Data
(60) Provisional application No. 61/772,695, filed on Mar. 5, 2013.

(51) Int. Cl. G06F 17/22

(52) U.S. Cl. CPC G06F 17/2247; G06F 17/2235
USPC 715/205

(57) ABSTRACT

Datasheets provide a summary of information about a complex component. A static datasheet provided by a website may be augmented to provide a static design assistance link within the displayed data sheet page. A set of information source links may be provided for display to the user of the website in response to activation of the design assistance link by the user. The plurality of information source links may each contain a link to a different portion of a database in the server containing design information relevant to using the component in a system design. A selected portion of design information may be provided from the database for display to the user in response to activation of one of the plurality of information source links by the user of the website.

### CLAIM OF PRIORITY UNDER 35 U.S.C. 119(e)

The present application claims priority to and incorporates by reference U.S. Provisional Application No. 61/772,695, (attorney docket TI-73562PS) filed Mar. 5, 2013, entitled “DATASHEET LOOK AND FEEL—DESIGN ACCELERATORS.”

### FIELD OF THE INVENTION

This invention generally relates to providing information to a designer of electronic systems, and more specifically to features of a web site.

### BACKGROUND OF THE INVENTION

Integrated circuits (IC) are typically complex electronic devices that are used as building blocks in various types of electronic systems. The designer of a system needs to understand the function and operating requirements of each IC in order to correctly design the system. The manufacturer of an IC may typically provide one or more reference documents that support component selection, HW design, and SW design associated with the IC. These documents may provide information that describes various aspects, such as: function, interface requirements, programming models, electrical characteristics, recommend specific methods of using the IC's functions, etc., for example.

A website is a set of related web pages served from a single web domain. A website is hosted on at least one web server, accessible via a network such as the Internet or a private local area network through an Internet address known as a Uniform resource locator. All publicly accessible websites collectively constitute the World Wide Web.

It is now common practice for a manufacturer to post the data sheets and other supporting documents for various ICs produced by the manufacturer on a website hosted by the manufacturer that may be accessed by different means.

### BRIEF DESCRIPTION OF THE DRAWINGS

Particular embodiments in accordance with the invention will now be described, by way of example only, and with reference to the accompanying drawings:

FIG. 1 is an example datasheet with an embedded link;

FIGS. 2-3 are example matrices of one-click action items;

FIG. 4 is a flow chart illustrating access of information via an active link in a datasheet; and

FIG. 5 is a block diagram of a web-server coupled to the World Wide Web.

Other features of the present embodiments will be apparent from the accompanying drawings and from the detailed description that follows.

### DETAILED DESCRIPTION OF EMBODIMENTS OF THE INVENTION

Specific embodiments of the invention will now be described in detail with reference to the accompanying figures. Like elements in the various figures are denoted by like reference numerals for consistency. In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

A typical system may include a few or several hundred integrated circuits (IC) that are mounted on one or more circuit boards. Various support logic, power sources, test logic, etc. is typically included in the system design. Generally, design engineers need certain information to enable the supplier's components to be used within various systems. An IC supplier may set up and host a website to provide this information via various documents. An exemplary supplier website may be found at ti.com, for example, which is hosted by Texas Instruments, Inc. One or more design engineers may utilize these documents supporting the use of the IC provided by its manufacturer.

It is common for an IC's manufacturer to organize the design information (design collateral) for different purposes. For example a data sheet may be provided to define the function and interface requirements of the IC. User guides may be provided to outline programming models and other information. Application notes may provide specific methods for interfacing electrical characteristics.

Data sheets are a popular starting point when a designer begins a system design as they provide important operating characteristics and often provide the designer with the information needed to select system components. Once the design is underway, datasheets provide additional detailed information required to ensure proper system operation. In general, datasheets provide a large amount of easily accessed information. However, in order to complete a system design, it is often necessary to access additional information beyond what is provided by the data sheet. In fact, in any phase of the design a designer may require access to information located in a multitude of design documents, each accessible in a different manner.

Creating a friendly user experience by providing easy access to all types of design collateral may make a vendor a preferred supplier. Embodiments of the invention may provide a friendly user experience by providing an instant access button in the header, or elsewhere in a data sheet or other document to provide direct paths to information such as: application notes, software, simulation models, samples, distribution availability, etc. In this manner, system designers may be able to obtain needed information faster and have a better design experience.

Typically, a vendor or supplier of components maintains a library or database of documents that describe the components offered by the vendor, such as: reference manuals, application notes, design guides, etc., for example. In addition, the vendor may offer additional design support items, such as: software, simulation models, evaluation models, samples, etc., for example. Previously, it was necessary to consult the various reference manuals, design guides, etc., in a more or less top down hierarchical manner. For example, a reference manual may be consulted, and it may have various sections that point the designer to other documents that contain related information. These documents may include further references to other documents. Therefore, it would often require accessing two or more documents to find a particular piece of relevant information. Furthermore, these documents may be organized by category, forcing them to be accessed in a hierarchical manner. Embodiments of the invention organize the various pieces of information in the vendor's database and/or in other databases available on the World Wide Web so that it may be accessed in a more horizontal (or flat) manner by a system designer using the datasheet or other document as a starting point. Since designers may frequently access the datasheet and may bookmark its location, providing access to other documents via the datasheet provides a gateway to all other documentation from a central location. This same paradigm may also be applied to other types of design documents to provide an entry point into a library of information in a more horizontal manner.

In one embodiment, an IC's datasheet can be constructed in a manner that provides a designer access to the IC's other design collateral from within its datasheet. The datasheet may be augmented to contain a means for a user to access a matrix of one-click action items that provide information that is relevant to various aspects of a system design. When this mechanism is provided in the datasheet header this capability becomes accessible from any page of the datasheet. In this manner, a quick one button link may be provided in the datasheet to expedite the designer's access to all design collateral. This means more time is spent using design collateral rather than looking for it, increasing a designer's productivity. This scheme can be used with other documents to provide immediate access to the datasheet and other documents. This approach provides the designer lateral movement between different forms of design collateral with minimal effort based on a well known entry point document such as a datasheet, as opposed to a hierarchical access mechanism that requires much more effort.

This approach also makes it easy to track the use of the various pieces of design collateral by recording the lateral movement between documents. Furthermore, referencing the documents via an alias or other similar means provides for configuration control and making the most recent copies of design collateral available. This process can be part of an automatic update process, for example. This becomes important when documents requiring static links (i.e. PDF documents) are utilized.

Portable Document Format (PDF) is a file format used to represent documents in a manner independent of application software, hardware, and operating system. Each PDF file encapsulates a complete description of a fixed-layout flat document, including the text, fonts, graphics, and other information needed to display it.

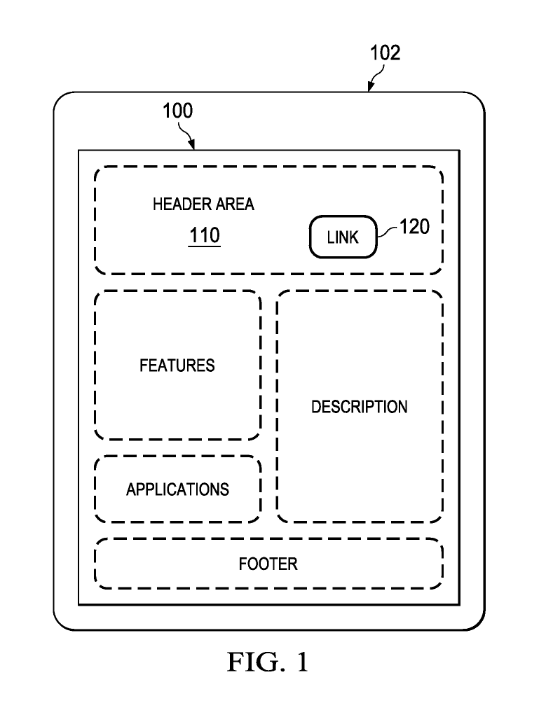

FIG. 1 is an example datasheet 100 with an embedded link 120 that is being displayed on a computer screen or display 102 in response to a system designer accessing a website of a supplier and selecting a particular IC, for example. As is well known, datasheets are currently provided in many configurations. In this example, there is a header area 110, and additional areas that may provide features, example applications, a general description, etc. Header area 110 may contain a device identification number and a supplier name or logo, for example. A data sheet may contain multiple pages that may contain more detailed descriptions, timing diagrams, package dimensions, pin out, etc. for example.

Computer screen or display 102 is representative of an type of device that may be used by a designer to access the web. Display 102 may be part of a desk top computer system, a portable personal computer, a tablet device, a smart phone or other mobile device, etc., for example.

Historically, datasheets were distributed in paper format. However, now vendors typically provide datasheets on a website using PDF or other known formats, such as HTML, etc., for example. As is well known, a website is a set of related web pages served from a single web domain. A website may be hosted on at least one web server, and is accessible via a network such as the Internet or a private local area network through an Internet address known as a uniform resource locator. All publicly accessible websites collectively constitute the World Wide Web.

A webpage is a document that is typically written in plain text interspersed with formatting instructions of Hypertext Markup Language (HTML, XHTML). A webpage may incorporate elements from other websites with suitable markup anchors. Webpages may be accessed and transported with the Hypertext Transfer Protocol (HTTP), which may optionally employ encryption (HTTP Secure, HTTPS) to provide security and privacy for the user of the webpage content. The user's application, often a web browser, renders the page content according to its HTML markup instructions onto a display terminal. The pages of a website usually may be accessed from a simple Uniform Resource Locator (URL) called the web address. The URLs of the pages organize them into a hierarchy, although hyperlinking between them conveys the reader's perceived site structure and guides the reader's navigation of the site which generally includes a home page with most of the links to the site's web content, and a supplementary “about, contact and link” page.

The general operation of websites is well known and need not be described in further detail herein. For example, a more detailed overview of website design and operation is provided in “Website”, available on Wikipedia, as modified on Feb. 10, 2014, which is incorporated by reference herein.

In one embodiment of the invention, a static link 120 may be placed in header area 110, or in other areas of the datasheet or in another entry point document that may be accessed by a designer. A designer that is viewing a website that is presenting datasheet 100 on a computer screen or display 102 may be interested in obtaining more information about the IC described by datasheet 100. In that case, the designer may click on, or otherwise activate, static link 120 and be provided with a set of dynamic links to additional information sources.

Static link 120 may be presented in several different manners, such as: in the form of a button that is displayed on the screen; in the form of an area that becomes highlighted in response to a pointer controlled by a pointing device such as a mouse, track ball, touch pad, etc or in response to a finger or other pointing device on a touch sensitive screen; by a gesture such as moving a finger across a touch screen or moving a mouse controlled pointer across a screen; etc., for example.

An embodiment of the invention may be implemented using datasheets or other entry point documents that are PDF documents. As such, the documents may not be available in HTML format that allows embedding of active hyperlinks for easy navigation between documents. In this case, a static link may be embedded in the PDF document that references a designated web address. When a request for more information is made by a user's activation of the static link, the link may provide a parameter to the designated web address that allows a backend process to identify which PDF document originated the request. The backend process may then provide the user with a set of one-click action items that allow the user to select a broad range of information resources, as will be described in more detail below.

Adding a static link to a static PDF document may be done in a number known or later developed ways. Acrobat X Pro provides a facility for doing this, for example. A manufacturer may have a library of thousands or tens of thousands of data sheets or other entry point documents for various components. Embedding a static link in each document that includes a parameter to identify that document allows the library to be updated with minimal effort. A backend process may then inspect the parameter provided with each assistance request initiated by activation of a static link and provide the correct set of one-click action items. In the manner, the various reference documents may be dynamically reconfigured and moved within a database, while the library of fixed PDF documents does not need to be updated each time a reference document is relocated within a database or library.

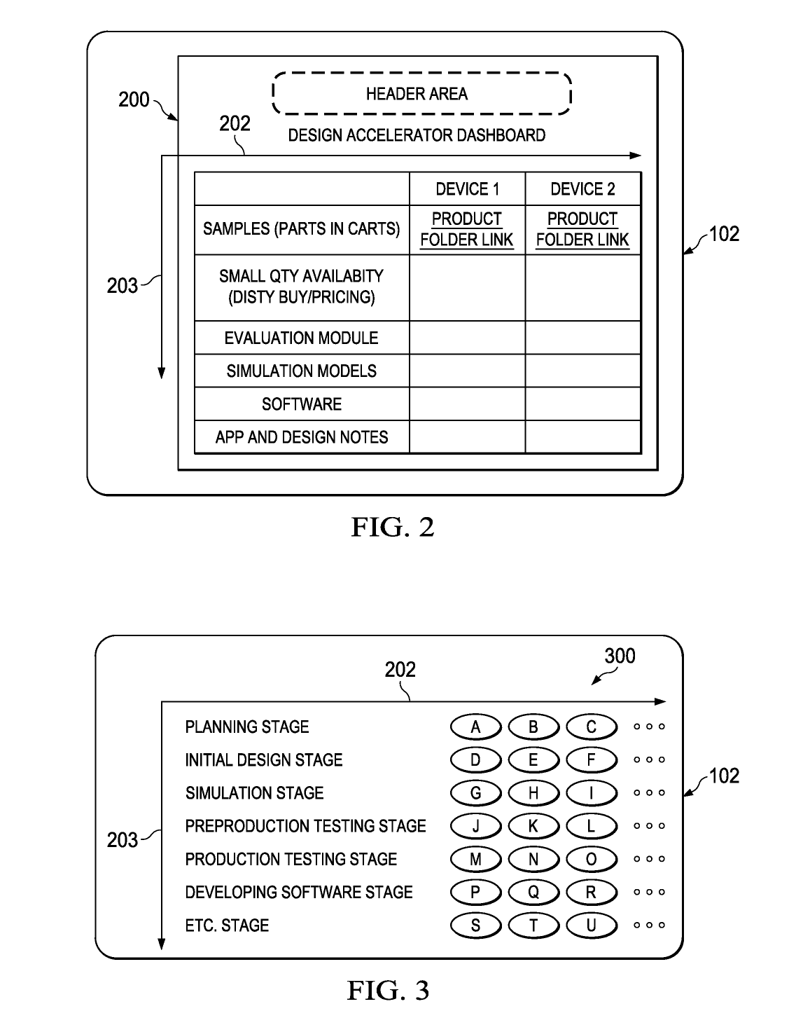

FIG. 2 is an example set 200 of dynamic one-click action items that may be presented on the computer screen or display 102 for the system designer in response to activating link 120. In this example, the set of one-click action items is arranged as a matrix with a column axis 202 and a row axis 203. In other embodiments, the set of one-click action items may be arranged in a different arrangement, such as: a single column, a diagram or illustration with various “hot spots” that may each provide a one-click action item, etc., for example.

One-click action items 200 may be arranged along row axis 203 in a manner to provide relevant information to a system designer that is interested in using the component of datasheet 100 in a system. The one-click links may provide different types of information, such as: information about samples, small quantity availability through distribution (disty), evaluation module, simulation models, software, application and design notes, etc., for example.

A set of one-click action items 200 may contain action items for two or more devices, such as “device 1” and “device 2”, for example, that are arranged in columns along column axis 202. These may be different versions of a device family represented by datasheet 100, for example.

In this example, the dynamic action items may be representations of hyperlinks. In computing, a hyperlink is a reference to data that the reader can directly follow either by clicking or by hovering or that may be followed automatically. A hyperlink may point to a whole document or to a specific element within a document. Hyperlink operation and technology is well known and need not be described in detail herein. A brief overview will be described below. A more detailed description of hyperlinks may be found in Wikipedia and elsewhere. For example, a Wikipedia article “Hyperlinks” as update 21 Feb. 2014 is incorporated by reference herein and contains references to multiple other articles on hyperlinks.

Hypertext is text with hyperlinks. A software system for viewing and creating hypertext is a hypertext system, and to create a hyperlink is to hyperlink (or simply to link). A user following hyperlinks is said to navigate or browse the hypertext.

A hyperlink has an anchor, which is the location within a certain type of a document from which the hyperlink can be followed only from the homepage; the document containing a hyperlink is known as its source code document. For example, in an online reference work, many words and terms in the text may be hyperlinked to definitions of those terms. Hyperlinks are often used to implement reference mechanisms, such as tables of contents, footnotes, bibliographies, indexes, letters, and glossaries.

The effect of following a hyperlink may vary with the hypertext system and may sometimes depend on the link itself; for instance, on the World Wide Web, most hyperlinks cause the target document to replace the document being displayed, but some are marked to cause the target document to open in a new window. Another possibility is transclusion, for which the link target is a document fragment that replaces the link anchor within the source document.

Embodiments of the invention configure a datasheet or other type of entry point document for an electronic component to be the homepage for accessing a complete dynamic library of information that pertains to the electronic component.

FIG. 3 is an example of set 300 of one-click action items that may be presented on the computer screen or display 102 for the system designer in response to activating static link 120. In this example, the set of one-click action items is arranged as a matrix with a column axis 202 and a row axis 203. In other embodiments, the set of one-click action items may be arranged in a different arrangement, such as: a single column, a diagram or illustration with various “hot spots” that may each provide a one-click action item, etc., for example. In this example, one-click action items 300 are arranged along row axis 203 in a manner that may correspond to a phase of designing a system using the component of datasheet 100, for example. In this case, links A, B, C, etc. provide access to information in the vendor's and/or other databases that pertain to planning stages of a design project using the component of datasheet 100. Additional links may provide additional information, such as: links D-F may provide information relative to an initial design stage; links G-I may provide information relative to simulation of a design using the component of datasheet 100; links J-L may provide information relative to preproduction testing of the design; links M-O may provide information relative to production testing of the design; links P-R may provide information relative to developing software for the design; etc., for example.

In this manner, a system designer may go to the datasheet or other document for a device and then easily find information relevant to whatever stage of the system design using that component is currently being worked on.

In other embodiments, one axis of the matrix may be arranged to correspond to types of information, such as: electrical, timing, and performance data; programming and control information; simulation information; testing information; application notes; design notes; provide the; etc., for example.

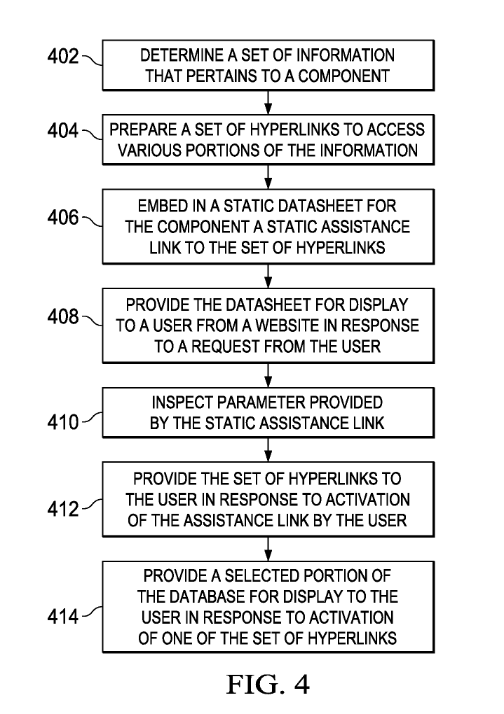

FIG. 4 is a flow chart illustrating access of information via an active link in a datasheet. A component vendor or manufacturer may have a website that provides information relating to hundreds or thousands of components, for example. Many of the components may be complex and require a large amount of information to allow various system designers and engineers to correctly use the complex components in a system design. The website may be constructed to allow system designers and engineers to access datasheets or other entry point documents that each provide a summary of information pertaining to a corresponding component.

Initially, a set of information that is available on one or more databases or libraries available on the website may be identified 402 that pertain to a particular component. A set of information source hyperlinks may be prepared 404 that allow parallel access to various portions of the information. As discussed above in more detail, the set of hyperlinks may be arranged to correspond to types of information, such as: electrical, timing, and performance data; programming and control information; simulation information; testing information; application notes; design notes; provide the; etc., for example. In another embodiment, the set of hyperlinks may be configured to access portions of the information based on different system design stages that may be involved with the component, for example.

A static datasheet 100 or other static entry point document for the component is augmented 406 to include a static design assistance link that links to a webpage that contains the set of information selection hyperlinks. As described in more detail above, a static document, such as a PDF document, may be easily augment by adding a static link that contains a fixed address to a website. The static link may also include a parameter that allows a backend processor to determine which static entry point document provided a request by activation of the static link.

When a user accesses the website and requests a datasheet for the component, a server containing the website information may provide 408 to the user's display 102 a data sheet page 100 for the component for display to the user. The static design assistance link 120 is provided within the displayed data sheet page for access by the user.

When activated by a user, the static design assistance link may send a parameter to a designated website address. Upon receipt of the request, a backend process may inspect 410 the parameter and determine for which component information is being requested.

The set of information source links is provided 412 for display to the user of the website in response to activation of the design assistance link by the user. The set of information source links each contain a link to a different portion of a database in the server containing design information relevant to using the component in a system design.

A selected portion of design information is provided 414 from the database for display to the user in response to activation of one of the plurality of information source links by the user of the website.

As described in more detail above, the set of information source links may be arranged in a matrix, such that one side of the matrix pertains to various stages of designing a system using the complex component. Alternately, one side of the matrix may pertain to various types of information that is available for the component. In some embodiments, another side of the information source link matrix may correspond to various types of components, such as members of a family of components, for example.

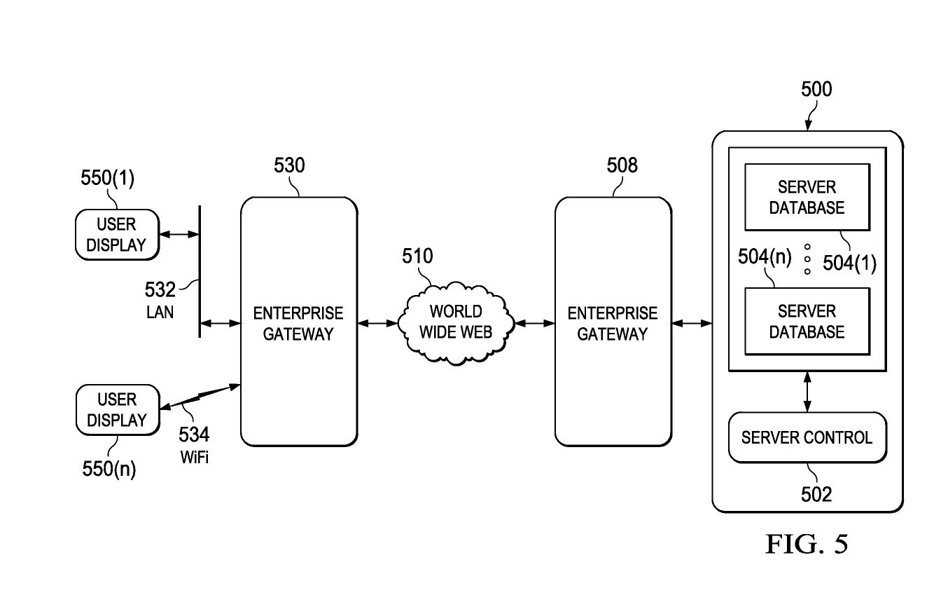

FIG. 5 is an example block diagram of a web-server 500 coupled to the World Wide Web 510. A website is a set of related web pages served from a single web domain. A website may be hosted on at least one web server such as server 500. Server 500 is accessible via a network such as the Internet or a private local area network through an Internet address known as a Uniform Resource Locator (URL). All publicly accessible websites collectively constitute the World Wide Web (web).

In this example, an enterprise, such as a business or a service provider for example, may connect to the web with an enterprise gateway 530 and then provide web connectivity to various user displays 550(1-n) via various combinations of local area networks (LAN) 532 and WiFi wireless connections 534, for example. The general operation of the web and access to it is well known and need not be described in further detail herein. User displays 550(1-n) are representative of the computer screen or display 102 described earlier.

Server 500 may include one or more control systems 502 and databases 504(1-n). Server 500 may be coupled to the web 510 via an enterprise gateway 508, for example. The general operation of web servers are well known, and need not be described in further detail herein. A web server may provide an embodiment of the invention by providing to one or more of the user displays 550(1-n) a data sheet page or other entry point document for an electronic component for display to the user of the website in response to a user request. As described above in more detail, a static design assistance link is provided within the displayed data sheet page. A plurality of information source links may be provided for display to user displays 550 of the website in response to activation of the design assistance link by the user. A backend process executed by control system 502 may determine which set of information source links to provide by inspecting a parameter provided by the static link as part of the request. The plurality of information source links may each contain a link to a different portion of a database(s) 504(1-n) in the server containing design information relevant to using the electronic component in a system design. A selected portion of design information may be provided from database 504 for display to user 550 in response to activation of one of the plurality of information source links by the user of the website.

As described in more detail above, the display of the plurality of information source links may be arranged in a matrix, such that one axis of the matrix corresponds to a phase of designing the system using the component, for example. In other embodiments, one axis of the matrix may be arranged to correspond to types of information, such as: electrical, timing, and performance data; programming and control information; simulation information; testing information; application notes; design notes; availability and pricing; etc., for example.

Embodiments of the invention provide an easy to access palette of information pertaining to an electronic component that can be accessed in a horizontal manner from an access point in a data sheet or other entry point document for the electronic component. In this manner, time spent searching for the various sources of data in various disparate places may be eliminated. In this manner, time spent traversing various hierarchical collections of information may be eliminated.

### Other Embodiments

While the invention has been described with reference to illustrative embodiments, this description is not intended to be construed in a limiting sense. Various other embodiments of the invention will be apparent to persons skilled in the art upon reference to this description. For example, while a method for providing information relevant to the design of electronic systems was described herein, other embodiments may be targeted for other types of components, such as: mechanical components, tools and machines, audio/visual components and system, etc., for example.

While embodiments were described herein for a library of static PDF datasheets or other entry point documents, other embodiments may include a mix of static PDF entry point documents and dynamic HTML based entry point documents, for example.

While PDF documents have been referred to herein, embodiments of the invention are applicable to any static form of document into which a static link may be embedded.

The techniques described in this disclosure may be implemented in hardware, software, firmware, or any combination thereof. If implemented in software, the software may be executed in one or more processors, such as a microprocessor, application specific integrated circuit (ASIC), field programmable gate array (FPGA), or digital signal processor (DSP). The software that executes the techniques may be initially stored in a computer-readable medium such as compact disc (CD), a diskette, a tape, a file, memory, or any other computer readable storage device and loaded and executed in the processor. In some cases, the software may also be sold in a computer program product, which includes the computer-readable medium and packaging materials for the computer-readable medium. In some cases, the software instructions may be distributed via removable computer readable media (e.g., floppy disk, optical disk, flash memory, USB key), via a transmission path from computer readable media on another digital system, etc.

Certain terms are used throughout the description and the claims to refer to particular system components. As one skilled in the art will appreciate, components in digital systems may be referred to by different names and/or may be combined in ways not shown herein without departing from the described functionality. This document does not intend to distinguish between components that differ in name but not function. In the following discussion and in the claims, the terms “including” and “comprising” are used in an open-ended fashion, and thus should be interpreted to mean “including, but not limited to . . . .” Also, the term “couple” and derivatives thereof are intended to mean an indirect, direct, optical, and/or wireless electrical connection. Thus, if a first device couples to a second device, that connection may be through a direct electrical connection, through an indirect electrical connection via other devices and connections, through an optical electrical connection, and/or through a wireless electrical connection.

Although method steps may be presented and described herein in a sequential fashion, one or more of the steps shown and described may be omitted, repeated, performed concurrently, and/or performed in a different order than the order shown in the figures and/or described herein. Accordingly, embodiments of the invention should not be considered limited to the specific ordering of steps shown in the figures and/or described herein.

It is therefore contemplated that the appended claims will cover any such modifications of the embodiments as fall within the true scope and spirit of the invention.

What is claimed is:

1. A method for providing information from a website, the method comprising:
providing to a user display device from a server containing website information a document page for a component for display to the user of the website in response to a user request, wherein a static design assistance link is provided within the displayed document page;
providing a plurality of information source links to the display device for display to the user of the website in response to activation of the design assistance link by the user, wherein the plurality of information source links each contain a link to a different portion of a database in the server containing design information relevant to using the component in a system design; and
providing a selected portion of design information from the database for display to the user in response to activation of one of the plurality of information source links by the user of the website.

2. The method of claim 1, wherein the document page is for a datasheet.

3. The method of claim 1, wherein the document page is a PDF document.

4. The method of claim 1, wherein the component is a complex electronic component.

5. The method of claim 1, wherein the display of the plurality of information source links is arranged in a matrix, such that one axis of the matrix corresponds to a phase of designing the system using the component.

6. The method of 5, wherein another axis of the matrix corresponds to various ones of a family of components.

7. The method of claim 1, further comprising:
determining a set of information available in the database available to the website that pertains to the component; and
preparing the plurality of information source links such that the set of information may be accessed in a parallel manner using the plurality of information source links.

8. The method of claim 1, augmenting a datasheet maintained on the website for the component to include the static design assistance link.

9. A web server, wherein the web server comprises:
an interface for coupling to the world wide web (web);
a storage system containing a database of information pertaining to a component;
a control system coupled to receive website requests from a user via the web and coupled to access the database, wherein the control system is configured to perform a method comprising:
receiving a request for a datasheet from a user of the website;
providing to a display device for the user from the storage system a document page for a component in response to a user request, wherein a static design assistance link is provided within the displayed document page;
providing a plurality of information source links to the display device for display to the user of the website in response to activation of the static design assistance link by the user, wherein the plurality of information source links each contain a link to a different portion of a database in the server containing design information relevant to using the component in a system design; and
providing a selected portion of design information from the database for display to the user in response to activation of one of the plurality of information source links by the user of the website.

10. The web server of claim 9, wherein the document page is for a datasheet.

11. The web server of claim 9, wherein the document page is a PDF document.

12. The web server of claim 9, wherein the component is a complex electronic component.

13. The web server of claim 9, wherein the display of the plurality of information source links is arranged in a matrix, such that one axis of the matrix corresponds to a phase of designing the system using the component.

14. The web server of 13, wherein another axis of the matrix corresponds to various ones of a family of components.
